(19) United States
(12) Patent Application Publication
(10) Pub. No.: US 2026/0343192 A1
(43) Pub. Date: Oct. 29, 2026

(54) METHOD FOR TRANSMITTING MESSAGE AND DEVICE FOR SAME IN WIRELESS COMMUNICATION SYSTEM

(71) Applicant: LG ELECTRONICS INC., Seoul (KR)

(72) Inventors: Jaeho Hwang, Seoul (KR); Hakseong Kim, Seoul (KR); Hanbyul Seo, Seoul (KR); Min Song, Seoul (KR); Seongwoo Jeong, Seoul (KR)

(21) Appl. No.: 19/111,748

(22) PCT Filed: Sep. 18, 2023
(86) PCT No.: PCT/KR2023/014048

§ 371 Date: Mar. 13, 2025

(30) Foreign Application Priority Data
Sep. 16, 2022 (KR) 10-2022-0117456

(51) Int. Cl. H04W 4/40; H04W 28/02

(52) U.S. Cl. CPC H04W 4/40; H04W 28/0236

(57) ABSTRACT

A method for a terminal to transmit real-time data to a network in a wireless communication system according to various embodiments may comprise the steps of: receiving configuration information about a vehicle to everything (V2X) message from the network; generating a V2X message on the basis of the configuration information; generating real-time data, based on the V2X message, for the system; and transmitting one of the first message or the V2X message first on the basis of the priority configured for the real-time data on the basis that the transmission period for the V2X message overlaps the transmission period for the first message.

### CROSS-REFERENCE TO RELATED APPLICATIONS

This application is a National Phase application under 35 U.S.C. 371 of International Application No. PCT/KR2023/014048, filed Sep. 18, 2023, which claims the benefit of Korean Application No. 10-2022-0117456, filed Sep. 16, 2022, the contents of which are incorporated by reference herein in their entirety.”

### TECHNICAL FIELD

The present disclosure relates to a method and apparatus for transmitting a message including real-time data to a network by a user equipment (UE) in a wireless communication system.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

A sidelink (SL) refers to a communication method in which a direct link is established between user equipment (UE), and voice or data is directly exchanged between terminals without going through a base station (BS). SL is being considered as one way to solve the burden of the base station due to the rapidly increasing data traffic.

V2X (vehicle-to-everything) refers to a communication technology that exchanges information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR). Even in NR, vehicle-to-everything (V2X) communication may be supported.

FIG. 1 is a diagram comparing RAT-based V2X communication before NR with NR-based V2X communication.

Regarding V2X communication, in RAT prior to NR, a scheme for providing a safety service based on V2X messages such as a basic safety message (BSM), a cooperative awareness message (CAM), and a decentralized environmental notification message (DENM) was mainly discussed. The V2X message may include location information, dynamic information, and attribute information. For example, the UE may transmit a periodic message type CAM and/or an event triggered message type DENM to another UE.

For example, the CAM may include dynamic state information about a vehicle such as direction and speed, vehicle static data such as dimensions, and basic vehicle information such as external lighting conditions and route details. For example, a UE may broadcast the CAM, and the CAM latency may be less than 100 ms. For example, when an unexpected situation such as a breakdown of the vehicle or an accident occurs, the UE may generate a DENM and transmit the same to another UE. For example, all vehicles within the transmission coverage of the UE may receive the CAM and/or DENM. In this case, the DENM may have a higher priority than the CAM.

Regarding V2X communication, various V2X scenarios have been subsequently introduced in NR. For example, the various V2X scenarios may include vehicle platooning, advanced driving, extended sensors, and remote driving.

For example, based on vehicle platooning, vehicles may dynamically form a group and move together. For example, to perform platoon operations based on vehicle platooning, vehicles belonging to the group may receive periodic data from a leading vehicle. For example, the vehicles belonging to the group may reduce or increase the distance between the vehicles based on the periodic data.

For example, based on advanced driving, a vehicle may be semi-automated or fully automated. For example, each vehicle may adjust trajectories or maneuvers based on data acquired from local sensors of nearby vehicles and/or nearby logical entities. Also, for example, each vehicle may share driving intention with nearby vehicles.

For example, on the basis of extended sensors, raw data or processed data acquired through local sensors, or live video data may be exchanged between a vehicle, a logical entity, UEs of pedestrians and/or a V2X application server. Thus, for example, the vehicle may recognize an environment that is improved over an environment that may be detected using its own sensor.

For example, for a person who cannot drive or a remote vehicle located in a dangerous environment, a remote driver or V2X application may operate or control the remote vehicle based on remote driving. For example, when a route is predictable as in the case of public transportation, cloud computing-based driving may be used to operate or control the remote vehicle. For example, access to a cloud-based back-end service platform may be considered for remote driving.

A method to specify service requirements for various V2X scenarios such as vehicle platooning, advanced driving, extended sensors, and remote driving is being discussed in the NR-based V2X communication field.

### SUMMARY

An object of the present disclosure is to provide a method and apparatus for, even if a V2X message and a first message including real-time data are transmitted respectively based on MQTT, minimizing the degradation of communication performance caused by the transmissions of the two messages by separately setting a priority for the real-time data.

It will be appreciated by persons skilled in the art that the objects that could be achieved with the various embodiments of the present disclosure are not limited to what has been particularly described hereinabove and the above and other objects that the various embodiments of the present disclosure could achieve will be more clearly understood from the following detailed description.

According to an aspect, a method of transmitting real-time data to a network by a user equipment (UE) in a wireless communication system may include receiving configuration information for a vehicle to everything (V2X) message from the network, generating the V2X message based on the configuration information, generating the real-time data for a system based on the V2X message, and based on a transmission period of the V2X message overlapping with a transmission period of the first message, transmitting one of the first message and the V2X message with priority, based on a priority configured for the real-time data. Based on the one message being the V2X message, transmission of the first message may be delayed until a first delay time being a time when transmission of the V2X message is completed or a second delay time being a time when a UE status is changed, based on the UE status. The UE status may be determined as a dangerous state or a safe state, based on a collision risk level calculated using status information obtained for the UE.

Alternatively, based on the transmission of the first message being delayed until the second delay time, the real-time data may be updated based on a length of a delay period from a generation time of the real-time data to the second delay time being equal to or greater than a specific threshold time.

Alternatively, the first message may include a vehicle to network (V2N) header including information about the priority of the real-time data.

Alternatively, based on the real-time data having the same priority as the transmission of the V2X message, a transmission time of the first message may be delayed until the first delay time, based on a generation time of the real-time data later than a generation time of the V2X message, or the transmission of the V2X message may be delayed until a time when the transmission of the first message is completed, based on the generation time of the V2X message later than the generation time of the real-time data.

Alternatively, based on the real-time data having the same priority as the transmission of the V2X message, the first message may be transmitted without delay based on the generation time of the real-time data earlier than the generation time of the V2X message.

Alternatively, based on the real-time data having a lower priority than the transmission of the V2X message, the transmission of the first message may be delayed until the first delay time based on the UE status being the safe state.

Alternatively, based on the real-time data having a lower priority than the transmission of the V2X message, the transmission of the first message may be delayed until the second time based on the UE status being the dangerous state.

Alternatively, the first message and the V2X message may be transmitted based on message queuing telemetry transport (MQTT).

According to another aspect, a UE for transmitting real-time data to a network may include a radio frequency (RF) transceiver and a processor connected to the RF transceiver. The processor may control the RF transceiver to receive configuration information for a V2X message from the network, generate the V2X message based on the configuration information, generate the real-time data for a system based on the V2X message, and based on a transmission period of the V2X message overlapping with a transmission period of the first message, transmit one of the first message and the V2X message with priority, based on a priority configured for the real-time data. Based on the one message being the V2X message, transmission of the first message may be delayed until a first delay time being a time when transmission of the V2X message is completed or a second delay time being a time when a UE status is changed, based on the UE status, and the UE status may be determined as a dangerous state or a safe state, based on a collision risk level calculated using status information obtained for the UE.

According to another aspect, a method of receiving real-time data from a UE by a network in a wireless communication system may include transmitting configuration information for a V2X message to the UE, and receiving one of the V2X message generated based on the configuration information and a first message including the real-time data generated for a system based on the V2X message, with priority. Based on the one message being the V2X message, reception of the first message may be delayed until a first delay time being a time when reception of the V2X message is completed or a second delay time being a time when a UE status is changed, based on the UE status. The UE status may be determined as a dangerous state or a safe state, based on a collision risk level calculated using status information obtained for the UE.

According to various embodiments, even if a V2X message and a first message including real-time data are transmitted respectively based on MQTT, the degradation of communication performance caused by the transmissions of the two messages may be minimized by separately setting a priority for the real-time data.

Alternatively, the transmission order of the V2X message and the first message may be efficiently determined by setting the priority for the real-time data based on the importance of the real-time data and the necessity of real-time acquisition.

Alternatively, even if the V2X message and the first message are transmitted based on MQTT, the transmission order of the V2X message and the first message may be determined based on the priority, thereby minimizing disruption to safety acquisition caused by the V2X message, while minimizing damage to the real-time nature of the real-time data.

Effects to be achieved by embodiment(s) are not limited to what has been particularly described hereinabove and other effects not mentioned herein will be more clearly understood by persons skilled in the art to which embodiment(s) pertain from the following detailed description.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram for explaining by comparing V2X communication based on RAT before NR and V2X communication based on NR.

FIG. 2 illustrates the structure of an LTE system to which embodiment(s) are applicable.

FIG. 3 illustrates the structure of an NR system to which embodiment(s) are applicable.

FIG. 4 illustrates the structure of an NR radio frame to which embodiment(s) are applicable.

FIG. 5 illustrates the slot structure of an NR frame to which embodiment(s) are applicable.

FIG. 6 illustrates a radio protocol architecture for SL communication.

FIG. 7 illustrates UEs performing V2X or SL communication.

FIG. 8 illustrates resource units for V2X or SL communication.

FIG. 9 is a diagram for explaining an ITS station reference architecture.

FIG. 10 illustrates an exemplary structure of an ITS station that may be designed and applied based on a reference architecture.

FIG. 11 is a diagram illustrating a method of transmitting and receiving a V2N message and/or a V2X message in a SoftV2X system.

FIG. 12 is a simplified block diagram illustrating the configuration of a system for transmitting data.

FIG. 13 is a simplified block diagram illustrating the configuration of a server that performs V2N communication.

FIG. 14 is a simplified block diagram illustrating the configuration of a UE that performs message transmission and reception with a server.

FIGS. 15 and 16 are diagrams illustrating a method of transmitting a real-time data message based on a priority configured for the real-time data message.

FIG. 17 is a diagram illustrating a method of transmitting a message including real-time data based on a priority by a UE.

FIG. 18 is a diagram illustrating the structure of a message including real-time data.

FIG. 19 is a diagram illustrating a method of transmitting a message including real-time data based on the priority of the real-time data by a UE.

FIG. 20 is a diagram illustrating a method of receiving a message including real-time data from a UE by a network.

FIG. 21 illustrates a communication system applied to the present disclosure.

FIG. 22 illustrates wireless devices applicable to the present disclosure.

FIG. 23 illustrates another example of a wireless device to which the present disclosure is applied.

FIG. 24 illustrates a vehicle or an autonomous driving vehicle applied to the present disclosure.

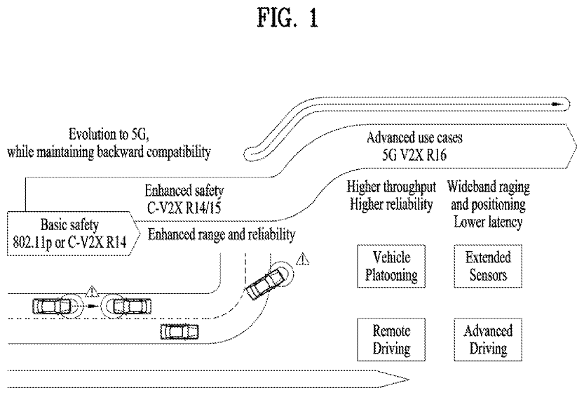

### DETAILED DESCRIPTION

The wireless communication system is a multiple access system that supports communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A and is a new clean-slate mobile communication system with characteristics such as high performance, low latency, and high availability. 5G NR may utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto

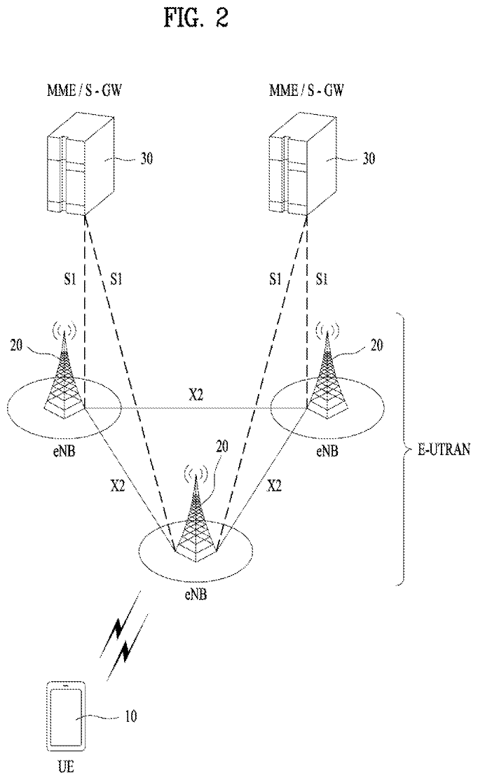

FIG. 2 illustrates the structure of an LTE system to which the present disclosure is applicable. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

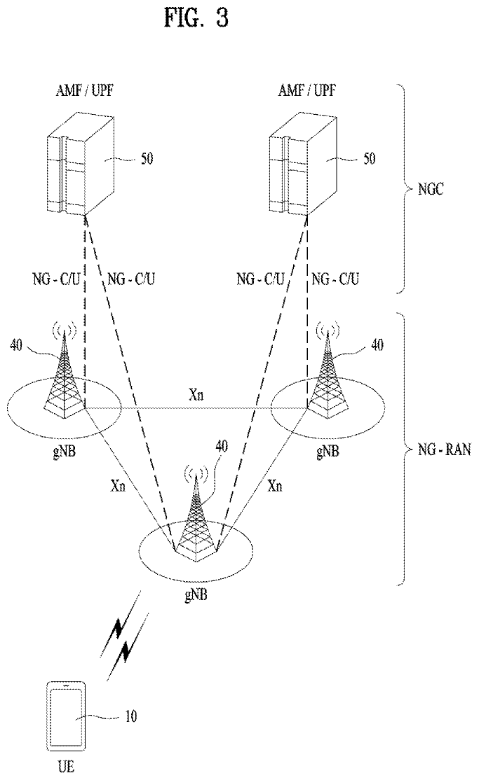

FIG. 3 illustrates the structure of a NR system to which the present disclosure is applicable.

Referring to FIG. 3, a next generation radio access network (NG-RAN) may include a next generation Node B (gNB) and/or an eNB, which provides user-plane and control-plane protocol termination to a UE. In FIG. 3, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

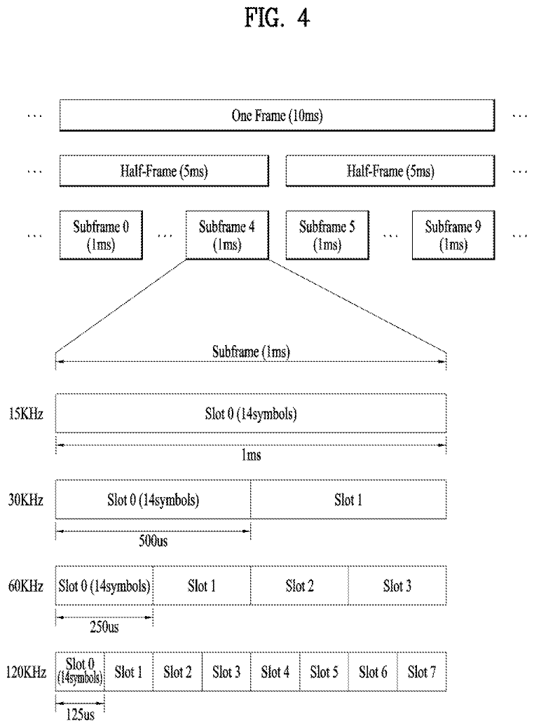

FIG. 4 illustrates the structure of a NR radio frame to which the present disclosure is applicable.

Referring to FIG. 4, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM (A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame,u}ₛₗₒₜ, and the number of slots per subframe N^{subframe,u}ₛₗₒₜ according to an SCS configuration μ in the NCP case.

TABLE 1

| | | | |
|---|---|---|---|
| SCS (15*2u) | N^{slot}_{symb} | N^{frame, u}ₛₗₒₜ | N^{subframe, u}ₛₗₒₜ |

| | | | | |
|---|---|---|---|---|
| 15 kHz | (u = 0) | 14 | 10 | 1 |
| 30 kHz | (u = 1) | 14 | 20 | 2 |
| 60 kHz | (u = 2) | 14 | 40 | 4 |
| 120 kHz | (u = 3) | 14 | 80 | 8 |
| 240 kHz | (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | Nslotsymb | Nframe, uslot | Nsubframe, uslot |
|---|---|---|---|
| 60 kHz (u = 2) | 12 | 40 | 4 |

In the NR system, different OFDM (A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

TABLE 3

| Frequency Range | Corresponding | Subcarrier |
|---|---|---|
| designation | frequency range | Spacing (SCS) |
| FR1 | 450 MHz-6000 MHz | 15, 30, 60 kHz |
| FR2 | 24250 MHz-52600 MHz | 60, 120, 240 kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHz (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

TABLE 4

| Frequency Range | Corresponding | Subcarrier |
|---|---|---|
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

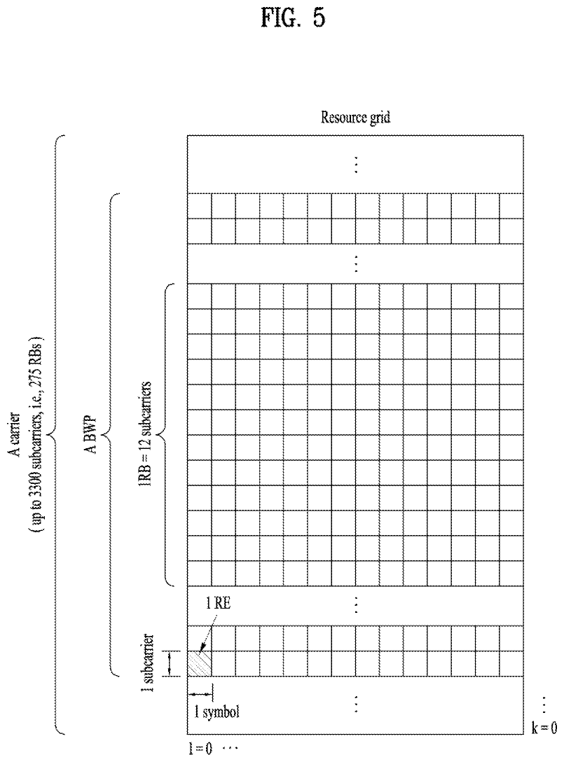

FIG. 5 illustrates the slot structure of a NR frame to which the present disclosure is applicable.

Referring to FIG. 5, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P) RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element may be referred to as a resource element (RE) and may be mapped to one complex symbol.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

Hereinafter, V2X or sidelink (SL) communication will be described.

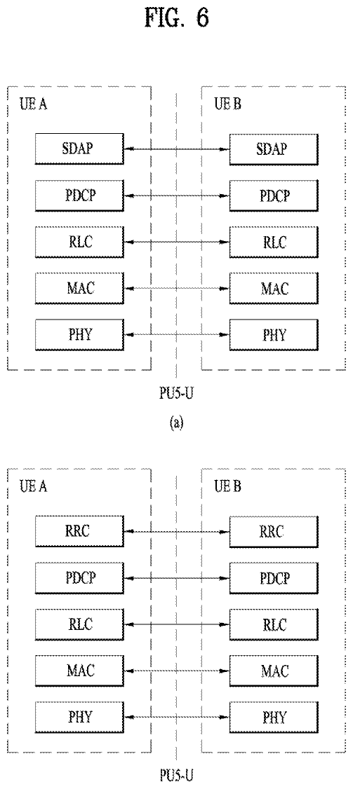

FIG. 6 illustrates a radio protocol architecture for SL communication. Specifically, FIG. 6-(a) shows a user plane protocol stack of NR, and FIG. 6-(b) shows a control plane protocol stack of NR.

Hereinafter, a sidelink synchronization signal (SLSS) and synchronization information will be described.

The SLSS is an SL-specific sequence, and may include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, the UE may detect an initial signal and acquire synchronization using the S-PSS. For example, the UE may acquire detailed synchronization using the S-PSS and the S-SSS, and may detect a synchronization signal ID.

A physical sidelink broadcast channel (PSBCH) may be a (broadcast) channel on which basic (system) information that the UE needs to know first before transmission and reception of an SL signal is transmitted. For example, the basic information may include SLSS related information, a duplex mode (DM), time division duplex uplink/downlink (TDD UL/DL) configuration, resource pool related information, the type of an application related to the SLSS, a subframe offset, and broadcast information. For example, for evaluation of PSBCH performance, the payload size of PSBCH in NR V2X may be 56 bits including CRC of 24 bits.

The S-PSS, S-SSS, and PSBCH may be included in a block format (e.g., an SL synchronization signal (SS)/PSBCH block, hereinafter sidelink-synchronization signal block (S-SSB)) supporting periodic transmission. The S-SSB may have the same numerology (i.e., SCS and CP length) as a physical sidelink control channel (PSCCH)/physical sidelink shared channel (PSSCH) in the carrier, and the transmission bandwidth thereof may be within a (pre) set sidelink BWP (SL BWP). For example, the bandwidth of the S-SSB may be 11 resource blocks (RBs). For example, the PSBCH may span 11 RBs. The frequency position of the S-SSB may be (pre) set. Accordingly, the UE does not need to perform hypothesis detection at a frequency to discover the S-SSB in the carrier.

In the NR SL system, a plurality of numerologies having different SCSs and/or CP lengths may be supported. In this case, as the SCS increases, the length of the time resource in which the transmitting UE transmits the S-SSB may be shortened. Thereby, the coverage of the S-SSB may be narrowed. Accordingly, in order to guarantee the coverage of the S-SSB, the transmitting UE may transmit one or more S-SSBs to the receiving UE within one S-SSB transmission period according to the SCS. For example, the number of S-SSBs that the transmitting UE transmits to the receiving UE within one S-SSB transmission period may be pre-configured or configured for the transmitting UE. For example, the S-SSB transmission period may be 160 ms. For example, for all SCSs, the S-SSB transmission period of 160 ms may be supported.

For example, when the SCS is 15 kHz in FR1, the transmitting UE may transmit one or two S-SSBs to the receiving UE within one S-SSB transmission period. For example, when the SCS is 30 kHz in FR1, the transmitting UE may transmit one or two S-SSBs to the receiving UE within one S-SSB transmission period. For example, when the SCS is 60 kHz in FR1, the transmitting UE may transmit one, two, or four S-SSBs to the receiving UE within one S-SSB transmission period.

For example, when the SCS is 60 kHz in FR2, the transmitting UE may transmit 1, 2, 4, 8, 16 or 32 S-SSBs to the receiving UE within one S-SSB transmission period. For example, when SCS is 120 kHz in FR2, the transmitting UE may transmit 1, 2, 4, 8, 16, 32 or 64 S-SSBs to the receiving UE within one S-SSB transmission period.

When the SCS is 60 kHz, two types of CPs may be supported. In addition, the structure of the S-SSB transmitted from the transmitting UE to the receiving UE may depend on the CP type. For example, the CP type may be normal CP (NCP) or extended CP (ECP). Specifically, for example, when the CP type is NCP, the number of symbols to which the PSBCH is mapped in the S-SSB transmitted by the transmitting UE may be 9 or 8. On the other hand, for example, when the CP type is ECP, the number of symbols to which the PSBCH is mapped in the S-SSB transmitted by the transmitting UE may be 7 or 6. For example, the PSBCH may be mapped to the first symbol in the S-SSB transmitted by the transmitting UE. For example, upon receiving the S-SSB, the receiving UE may perform an automatic gain control (AGC) operation in the period of the first symbol for the S-SSB.

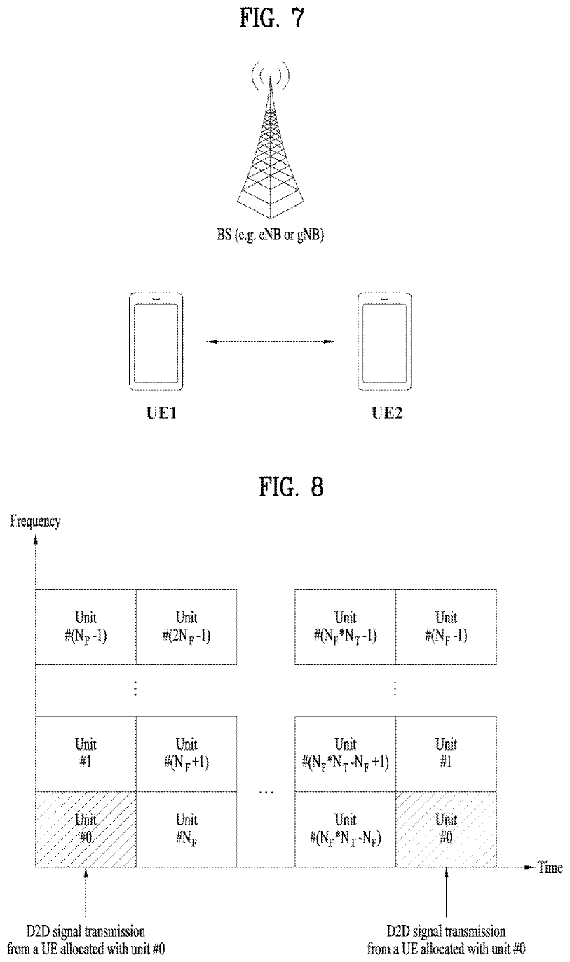

FIG. 7 illustrates UEs performing V2X or SL communication.

Referring to FIG. 7, in V2X or SL communication, the term UE may mainly refer to a user's UE. However, when network equipment such as a BS transmits and receives signals according to a communication scheme between UEs, the BS may also be regarded as a kind of UE. For example, UE 1 may be the first device 100, and UE 2 may be the second device 200.

For example, UE 1 may select a resource unit corresponding to a specific resource in a resource pool, which represents a set of resources. Then, UE 1 may transmit an SL signal through the resource unit. For example, UE 2, which is a receiving UE, may receive a configuration of a resource pool in which UE 1 may transmit a signal, and may detect a signal of UE 1 in the resource pool.

Here, when UE 1 is within the connection range of the BS, the BS may inform UE 1 of a resource pool. On the other hand, when the UE 1 is outside the connection range of the BS, another UE may inform UE 1 of the resource pool, or UE 1 may use a preconfigured resource pool.

In general, the resource pool may be composed of a plurality of resource units, and each UE may select one or multiple resource units and transmit an SL signal through the selected units.

FIG. 8 illustrates resource units for V2X or SL communication.

Referring to FIG. 8, the frequency resources of a resource pool may be divided into NF sets, and the time resources of the resource pool may be divided into NT sets. Accordingly, a total of NF*NT resource units may be defined in the resource pool. FIG. 8 shows an exemplary case where the resource pool is repeated with a periodicity of NT subframes.

As shown in FIG. 8, one resource unit (e.g., Unit #0) may appear periodically and repeatedly. Alternatively, in order to obtain a diversity effect in the time or frequency dimension, an index of a physical resource unit to which one logical resource unit is mapped may change in a predetermined pattern over time. In this structure of resource units, the resource pool may represent a set of resource units available to a UE which intends to transmit an SL signal.

Resource pools may be subdivided into several types. For example, according to the content in the SL signal transmitted in each resource pool, the resource pools may be divided as follows.
(1) Scheduling assignment (SA) may be a signal including information such as a position of a resource through which a transmitting UE transmits an SL data channel, a modulation and coding scheme (MCS) or multiple input multiple output (MIMO) transmission scheme required for demodulation of other data channels, and timing advance (TA). The SA may be multiplexed with SL data and transmitted through the same resource unit. In this case, an SA resource pool may represent a resource pool in which SA is multiplexed with SL data and transmitted. The SA may be referred to as an SL control channel.
(2) SL data channel (physical sidelink shared channel (PSSCH)) may be a resource pool through which the transmitting UE transmits user data. When the SA and SL data are multiplexed and transmitted together in the same resource unit, only the SL data channel except for the SA information may be transmitted in the resource pool for the SL data channel. In other words, resource elements (REs) used to transmit the SA information in individual resource units in the SA resource pool may still be used to transmit the SL data in the resource pool of the SL data channel. For example, the transmitting UE may map the PSSCH to consecutive PRBs and transmit the same.
(3) The discovery channel may be a resource pool used for the transmitting UE to transmit information such as the ID thereof. Through this channel, the transmitting UE may allow a neighboring UE to discover the transmitting UE.

Even when the SL signals described above have the same content, they may use different resource pools according to the transmission/reception properties of the SL signals. For example, even when the SL data channel or discovery message is the same among the signals, it may be classified into different resource pools according to determination of the SL signal transmission timing (e.g., transmission at the reception time of the synchronization reference signal or transmission by applying a predetermined TA at the reception time), a resource allocation scheme (e.g., the BS designates individual signal transmission resources to individual transmitting UEs or individual transmission UEs select individual signal transmission resources within the resource pool), signal format (e.g., the number of symbols occupied by each SL signal in a subframe, or the number of subframes used for transmission of one SL signal), signal strength from a BS, the strength of transmit power of an SL UE, and the like.

### Vehicular Communications for ITS

An intelligent transport system (ITS) utilizing vehicle-to-everything (V2X) may mainly include an access layer, a network & transport layer, a facilities layer, an application layer, security and management entities, etc. Vehicle communication may be applied to various scenarios such as vehicle-to-vehicle communication (V2V), vehicle-to-network communication (V2N or N2V), vehicle-to-road side unit (RSU) communication (V2I or I2V), RSU-to-RSU communication (I2I), vehicle-to-pedestrian communication (V2P or P2V), and RSU-to-pedestrian communication (I2P or P2I). A vehicle, a BS, an RSU, a pedestrian, etc. as the subjects of vehicle communication are referred to as ITS stations.

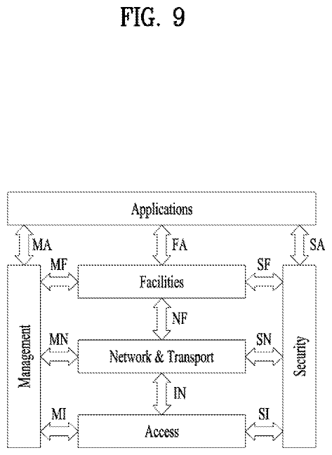

FIG. 9 is a diagram for explaining an ITS station reference architecture.

The ITS station reference architecture may include an access layer, a network & transport layer, a facilities layer, entities for security and management, and an application layer at the top. Basically, the ITS station reference architecture follows a layered OSI model.

Specifically, features of the ITS station reference architecture based on the OSI model are illustrated in FIG. 9. The access layer of the ITS station corresponds to OSI layer 1 (physical layer) and layer 2 (data link layer), the network & transport layer of the ITS station corresponds to OSI layer 3 (network layer) and layer 4 (transport layer), and the facilities layer of the ITS station corresponds to OSI layer 5 (session layer), layer 6 (presentation layer), and layer 7 (application layer).

The application layer, which is located at the highest layer of the ITS station, may actually implement and support a use-case and may be selectively used according to the use-case. The management entity serves to manage all layers in addition to managing communication and operations of the ITS station. The security entity provides security services for all layers. Each layer of the ITS station exchanges data transmitted or received through vehicle communication and additional information for various purposes through an interface. The abbreviations of various interfaces are described below.
MA: Interface between management entity and application layer
MF: Interface between management entity and facilities layer
MN: Interface between management entity and networking & transport layer
MI: Interface between management entity and access layer
FA: Interface between facilities layer and ITS-S applications
NF: Interface between networking & transport layer and facilities layer
IN: Interface between access layer and networking & transport layer
SA: Interface between security entity and ITS-S applications
SF: Interface between security entity and facilities layer
SN: Interface between security entity and networking & transport layer
SI: Interface between security entity and access layer

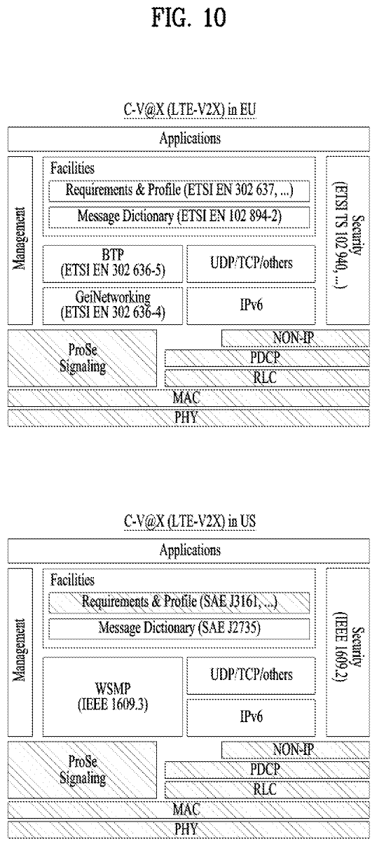

FIG. 10 illustrates an exemplary structure of an ITS station that may be designed and applied based on a reference architecture.

A main concept of the ITS station reference architecture is to allow each layer with a special function to process communication on a layer basis, between two end vehicles/users included in a communication network. That is, when a V2V message is generated, the data is passed through each layer downwards layer by layer in the vehicle and the ITS system (or other ITS-related UEs/systems), and a vehicle or ITS system (or other ITS-related UEs/systems) receiving the message passes the message upwards layer by layer.

The ITS system operating through vehicle communication and the network was organically designed in consideration of various access technologies, network protocols, communication interfaces, etc. to support various use-cases, and the roles and functions of each layer described below may be changed depending on a situation. The main functions of each layer will be briefly described.

The application later actually implements and supports various use-cases. For example, the application layer provides security, efficient traffic information, and other entertainment information.

The application layer controls an ITS station to which an application belongs in various manners or provides services by transferring a service message to an end vehicle/user/infrastructure through the access layer, the network & transport layer, and the facilities layer, which are lower layers of the application layer, by vehicle communication. In this case, the ITS application may support various use-cases. In general, these use-cases may be supported by grouping into other applications such as road-safety, traffic efficiency, local services, and infotainment. Application classification, use-cases, etc. may be updated when a new application scenario is defined. Layer management serves to manage and service information related to operation and security of the application layer, and the related information is transmitted and shared bidirectionally through an MA and an SA (or service access point (SAP), e.g. MA-SAP or SA-SAP). A request from the application layer to the facilities layer or a service message and related information from the facilities layer to the application layer may be delivered through an FA.

The facilities layer serves to support effective implementation of various use-cases defined in an application layer of a higher layer. For example, the facilities layer may perform application support, information support, and session/communication support.

The facilities layer basically supports the 3 higher layers of the OSI model, for example, a session layer, a presentation layer, and the application layer, and functions. Specifically, the facilities layer provides facilities such as application support, information support, and session/communication support, for the ITS. Here, the facilities mean components that provide functionality, information, and data.

The application support facilities support the operation of ITS applications (mainly generation of a message for the ITS, transmission and reception of the message to and from a lower layer, and management of the message). The application support facilities include a cooperative awareness (CA) basic service and a decentralized environmental notification (DEN) basic service. In the future, facilities entities for new services such as cooperative adaptive cruise control (CACC), platooning, a vulnerable roadside user (VRU), and a collective perception service (CPS), and related messages may be additionally defined.

The information support facilities provide common data information or a database to be used by various ITS applications and includes a local dynamic map (LDM).

The session/communication support facilities provide services for communications and session management and include an addressing mode and session support.

Facilities may be divided into common facilities and domain facilities.

The common facilities are facilities that provide common services or functions required for various ITS applications and ITS station operations, such as time management, position management, and service management.

The domain facilities are facilities that provide special services or functions required only for some (one or more) ITS applications, such as a DEN basic service for road hazard warning applications (RHW). The domain facilities are optional functions and are not used unless supported by the ITS station.

Layer management serves to manage and service information related to the operation and security of the facilities layer, and the related information is transmitted and shared bidirectionally through an MF and an SF (or MF-SAP and SF-SAP). The transfer of service messages and related information from the application layer to the facilities layer or from the facilities layer to the application layer is performed through an FA (or FA-SAP), and bidirectional service messages and related information between the facilities layer and the lower networking & transport layer are transmitted by an NF (or NF-SAP).

The network & transport layer servers to configure a network for vehicle communication between homogenous or heterogeneous networks through support of various transport protocols and network protocols. For example, the network & transport layer may provide Internet access, routing, and vehicle networking using Internet protocols such as TCP/UDP+IPv6 and form a vehicle network using a basic transport protocol (BTP) and GeoNetworking-based protocols. In this case, networking using geographic position information may also be supported. A vehicle network layer may be designed or configured depending on technology used for the access layer (access layer technology-independently) or regardless of the technology used for the access layer (access layer technology-independently or access layer technology agnostically).

Functionalities of the European ITS network & transport layer are as follows. Basically, functionalities of the ITS network & transport layer are similar to or identical to those of OSI layer 3 (network layer) and layer 4 (transport layer) and have the following characteristics.

The transport layer is a connection layer that delivers service messages and related information received from higher layers (the session layer, the presentation layer, and the application layer) and lower layers (the network layer, the data link layer, and the physical layer). The transport layer serves to manage data transmitted by an application of the ITS station so that the data accurately arrives at an application process of the ITS station as a destination. Transport protocols that may be considered in European ITS include, for example, TCP and UDP used as legacy Internet protocols, and there are transport protocols only for the ITS, such as the BTS.

The network layer serves to determine a logical address and a packet forwarding method/path, and add information such as the logical address of a destination and the forwarding path/method to a header of the network layer in a packet received from the transport layer. As an example of the packet method, unicast, broadcast, and multicast between ITS stations may be considered. Various networking protocols for the ITS may be considered, such as GeoNetworking, IPv6 networking with mobility support, and IPV6 over GeoNetworking. In addition to simple packet transmission, the GeoNetworking protocol may apply various forwarding paths or transmission ranges, such as forwarding using position information about stations including vehicles or forwarding using the number of forwarding hops.

Layer management related to the network & transport layer serves to manage and provide information related to the operation and security of the network & transport layer, and the related information is transmitted and shared bidirectionally through an MN (or MN-SAP) and an SN (or SN-SAP). Transmission of bidirectional service messages and related information between the facilities layer and the networking & transport layer is performed by an NF (or NF-SAP), and service messages and related information between the networking & transport layer and the access layer are exchanged by an IN (or IN-SAP).

A North American ITS network & transport layer supports IPV6 and TCP/UDP to support existing IP data like Europe, and a wave short message protocol (WSMP) is defined as a protocol only for the ITS.

A packet structure of a wave short message (WSM) generated according to the WSMP includes a WSMP header and WSM data carrying a message. The WSMP header includes Version, PSID, WSMP header extension fields, WSM WAVE element ID, and Length.

Version is defined by a WsmpVersion field indicating an actual WSMP version of 4 bits and a reserved field of 4 bits. PSID is a provider service identifier, which is allocated according to an application in a higher layer and helps a receiver to determine an appropriate higher layer. Extension fields is a field for extending the WSMP header, and includes information such as a channel number, a data rate, and transmit power used. WSMP WAVE element ID specifies the type of a WSM to be transmitted. Length specifies the length of transmitted WSM data in octets through a WSMLength field of 12 bits, and the remaining 4 bits are reserved. LLC Header allows IP data and WSMP data to be transmitted separately and is distinguished by Ethertype of a SNAP. The structures of the LLC header and the SNAP header are defined in IEEE802.2. When IP data is transmitted, Ethertype is set to 0x86DD in the LLC header. When WSMP is transmitted, Ethertype is set to 0x88DC in the LLC header. The receiver identifies Ethertype. If Ethertype is 0x86DD, the receiver transmits upward the packet to an IP data path, and if Ethertype is 0x88DC, the receiver transmits upward the packet to a WSMP path.

The access layer serves to transmit a message or data received from a higher layer on a physical channel. As access layer technologies, ITS-G5 vehicle communication technology based on IEEE 802.11p, satellite/broadband wireless mobile communication technology, 2G/3G/4G (long-term evolution (LTE), etc.)/5G wireless cellular communication technology, cellular-V2X vehicle-dedicated communication technologies such as LTE-V2X and NR-V2X (new radio), broadband terrestrial digital broadcasting technology such as DVB-T/T2/ATSC3.0, and GPS technology may be applied.

A data link layer is a layer that converts a physical line between adjacent nodes (or between vehicles) with noise into a communication channel without transmission error, for use in the higher network layer. The data link layer performs a function of transmitting/delivering/forwarding L3 protocols, a framing function of dividing data to be transmitted into packets (or frames) as transmission units and grouping the packets, a flow control function of compensating for a speed difference between a transmitter and a receiver, and a function of (because there is a high probability that an error and noise occurs randomly in view of the nature of a physical transmission medium) detecting a transmission error and correcting the error or detecting a transmission error based on a timer and an ACK signal by a transmitter in a method such as automatic repeat request (ACK) and retransmitting a packet that has not been correctly received. In addition, to avoid confusion between packets or ACK signals, the data link layer performs a function of assigning a sequence number to the packets and the ACK signals, and a function of controlling establishment, maintenance, and disconnection of a data link between network entities, and data transmission between network entities. The main functions of logical link control (LLC), radio resource control (RRC), packet data convergence protocol (PDCP), radio link control (RLC), medium access control (MAC), and multi-channel operation (MCO) included in the data link layer will be described below.

An LLC sub-layer enables the use of different lower MAC sub-layer protocols, and thus enables communication regardless of network topology. An RRC sub-layer performs functions such as broadcasting of cell system information required for all UEs within a cell, management of delivery of paging messages, management (setup/maintenance/release) of RRC connection between a UE and an E-UTRAN, mobility management (handover), transmission of UE context between eNodeBs during handover, UE measurement reporting and control therefor, UE capability management, temporary assignment of a cell ID to a UE, security management including key management, and RRC message encryption. A PDCP sub-layer may performs functions such as IP packet header compression in a compression method such as robust header compression (ROHC), cyphering of a control message and user data, data integrity, and data loss prevention during handover. RLC sub-layer delivers a packet received from the higher PDCP layer in an allowed size of the MAC layer through packet segmentation/concatenation, increases data transmission reliability by transmission error and retransmission management, checks the order of received data, reorders data, and checks redundancy. A MAC sub-layer performs functions such as control of the occurrence of collision/contention between nodes for use of shared media among multiple nodes, matching a packet delivered from the higher layer to a physical layer frame format, assignment and identification of the address of the transmitter/receiver, detection of a carrier, collision detection, and detection of obstacles on the physical medium. An MCO sub-layer enables efficient provision of various services on a plurality of frequency channels. The main function of MCO sub-layer is to effectively distribute traffic load of a specific frequency channel to other channels to minimize collision/contention of communication information between vehicles in each frequency channel.

The physical layer is the lowest layer in the ITS layer architecture. The physical layer defines an interface between a node and a transmission medium and performs modulation, coding, and mapping of a transport channel to a physical channel, for bit transmission between data link layer entities and informs the MAC sub-layer of whether a wireless medium is busy or idle by carrier sensing or clear channel assessment (CCA).

A Soft V2X system may be a system in which a Soft V2X server receives a VRU message or a personal safety message (PSM) from a vulnerable road user (VRU) or a V2X vehicle and transfers information on a neighbor VRU or vehicle based on the VRU message or the PSM message or may analyze a road condition, etc. on which neighbor VRUs or vehicles move and may transmit a message informing a neighbor VRU or vehicle of a collision warning, etc. based on the analyzed information (e.g., through a downlink signal) via V2X communication using a UU interface. Here, the VRU message may be a message transmitted to the Soft V2X server through the UU interface, and may include mobility information about the VRU, such as a position, a movement direction, a movement path, and a speed of the VRU. That is, the Soft V2X system may use a method of receiving mobility information of VRUs and/or vehicles related to V2X communication through the UU interface and controlling a driving route or a VRU movement flow of the VRU, etc. based on the mobility information received by the Soft V2X server, such as a network. The Soft V2X system may be configured in relation to V2N communication.

User equipment or pedestrian equipment (VRU device) that is difficult to perform direct communication (PC5, DSRC) related to V2X communication can provide or receive driving information and mobility information to nearby vehicles or VRUs through the Soft V2X system based on the UU interface. Through this, the user equipment or pedestrian equipment (VRU device) that is difficult to perform the direct communication (PC5, DSRC) can be protected from surrounding vehicles.

### MQTT-Based Transmission of Real-Time Data for V2X

Compared to a broadcast communication method in which all neighboring UEs receive a message, such as conventional short-range communication, in V2N communication, a V2X message may be transmitted using a cellular network, and a V2N server may classify UL V2N messages (V2N messages including V2X messages) according to an established rule in view of the nature of long-range communication and transmit the classified messages to each corresponding UE on DL. To this end, the V2N server may transmit V2X messages to UEs using a Message Queuing Telemetry Transport (MQTT) transmission method based on a cellular network. However, for a V2X service, real-time data as well as V2X messages needs to be transmitted. A method of creating separate socket communication for such data transmission has a disadvantage in that it requires an additional technology and device for managing UEs. As another method, a method of using MQTT of V2X may be considered. However, the method of using MQTT of V2X may damage the real-time nature of V2X messages.

In consideration of these problems, a method of transmitting real-time data using an MQTT device or a message through V2X communication will be described below in detail. An MQTT communication method using a cellular network may not ensure the real-time nature due to the number of UEs within a service area, the status of a communication channel, and the processing capability of a server, as described above. For example, priorities may not be handled in the MQTT communication method, and when a data transmission is performed in addition to a V2X message transmission, these two communications may be degraded. To minimize the communication degradation, a method of setting a priority for real-time data and transmitting the real-time data based on the priority in a relationship with transmission of a V2X message in the method of processing real-time data based on MQTT is proposed below.

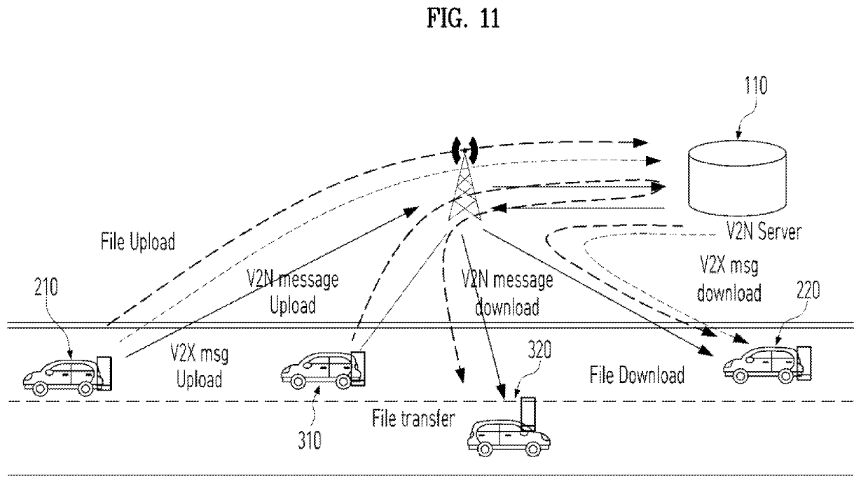

FIG. 11 is a diagram illustrating a method of transmitting and receiving a V2N message and/or a V2X message in a SoftV2X system.

Referring to FIG. 11, the SoftV2X system may include vehicles 210, 310, 320, and 330 including V2X UEs, and a V2N server 110 that connects them by communication. A V2X UE 210 may perform a message transmission function of transmitting its status to the V2N server and a function of transmitting real-time data in addition to a V2X message using the same network. A UE 220 may receive a V2X message and real-time data from the V2N server. In addition, as in short-range communication, a first vehicle 310 and a second vehicle 320 may transmit files or data (or real-time data) to each other through communication. To this end, the first vehicle 310 and the second vehicle 320 may transmit or receive real-time data through the V2N server 110, or perform peer-to-peer network (P2P) communication based on a separately allocated communication channel between two UEs.

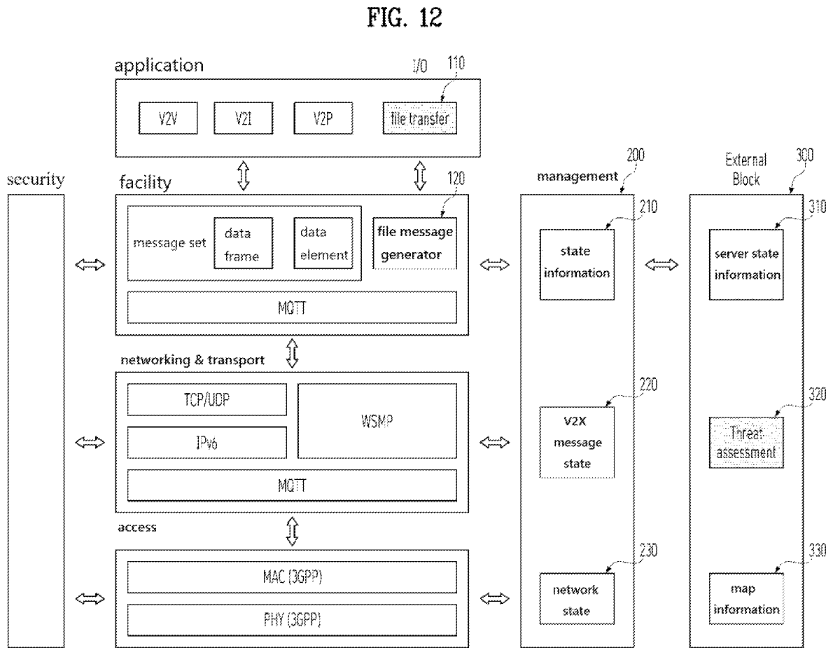

FIG. 12 is a simplified block diagram illustrating the configuration of a system for data transmission.

Referring to FIG. 12, for the system, a device or configuration for file/data transmission may be added to a conventional V2X communication system. In an application layer, a file transfer block 110 may be added for real-time file/data transmission in addition to a conventional V2X message transmission service. In a facility layer, a data msg generator block 120 may generate a message for MQTT-based real-time data based on a file (or real-time data) received from a higher layer and a priority. In particular, due to the characteristics of the MQTT technology in which priorities may not be managed, a function 121 for coordinating between a V2X message generation block and a data message generation block needs to be configured. Information managed in a management block 200 and an external block 300 may be used to generate/transmit the message.

Specifically, the management block 200 may identify a risk state and current movement state of a device or a UE through a status information block 210, identify the transmission status of a V2X message using a V2X message status block 220, and identify the transmission status of a communication network using a network status block 230. For example, the status information block 210 may predict/identify the risk state of the UE based on whether there are other devices or other UEs that may collide with the UE based on mobility information about the device or the UE, location information, map information, and information (e.g., information about the locations and mobility of other UEs) included in messages received from the other UEs (and/or the server). For example, when the UE is located adjacent to a road or adjacent to an approaching vehicle by a specific threshold or more, the status information block 210 may predict/identify the status of the UE as a dangerous state.

The external management block 300 may identify the processing capacity of the server using a server status information block 310, and generate a real-time data/file transfer message using information about the identified processing capacity of the server. In the case of the UE, the status of the server received from the server may be used. A threat assessment (TA) block 320 may be used to generate a real-time data/file transfer message based on risk information about the UE. For example, when the UE is evaluated as being in a high risk state through the TA block, a low-priority real-time data transmission may be delayed or dropped. Alternatively, when the UE is evaluated as located in an area far from a risk area and thus in a safe state through the TA block, the transmission amount of the real-time data may be significantly increased. Finally, a map information block 330 may be used to control whether to generate real-time data and a (generation) period based on the location of the UE on a map.

A file/data generated in the application layer may be generated as a message for file/data transmission in the facility layer. Real-time data should be transmitted without interfering with the original purpose of a V2X system, which is V2X safety protection. To this end, a priority may be set for the transmission of the real-time data, and transmission resources may be shared between the transmission of the real-time data and a V2X message, based on the priority.

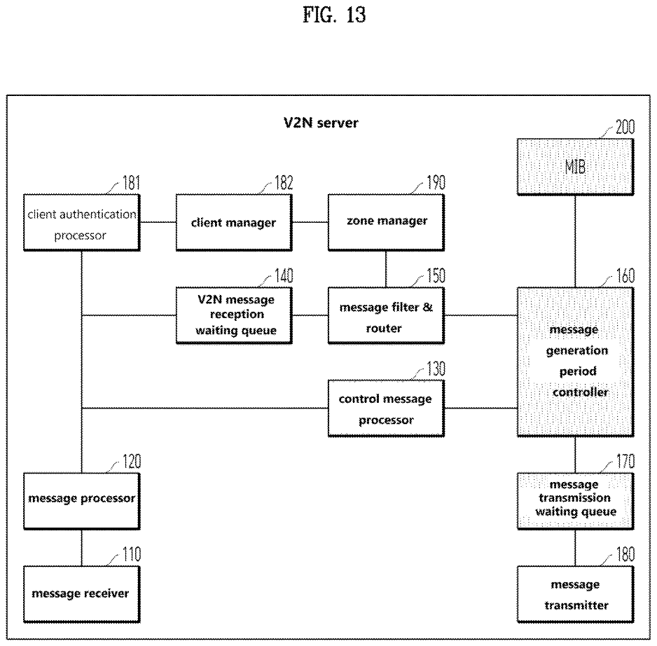

FIG. 13 is a simplified block diagram illustrating the configuration of a server that performs V2N communication.

Referring to FIG. 13, the server may include a message receiver 110, a message processor 120, a control message processor 130, a message filter & router 150, a message generation period controller 160, a transmission waiting queue 170, a client authentication processor 181, a client manager 182, a zone manager 190, and an MIB 200 of management.

The message receiver 110 and the message processor 120 may receive messages (e.g., V2X messages or V2N messages) from UEs/devices and process the received messages. The control message processor 130 may process control data included in a control message received from a UE, transmit the processed control data to another block, or generate directly generated real-time data as a (control) message. The message generation period controller 160 may adjust the order of a (V2X or V2N) message received from the message filter & router 150 (wherein the received message is delivered to related UEs) and a real-time message (i.e., the order between the transmission of a message for delivering the received message and the transmission of the real-time data). Alternatively, the message generation period controller 160 may perform buffering/filtering (e.g., on the real-time message, the V2N message, and/or a V2X message) using the priority and status parameters of the (real-time) message (e.g., status parameters for the UE, server, and network managed in the MIB 200 of management). The message generation period controller 160 may transmit data for the message to the transmission queue 170, and the message for the real-time data and/or the received message may be transmitted through an MQTT protocol.

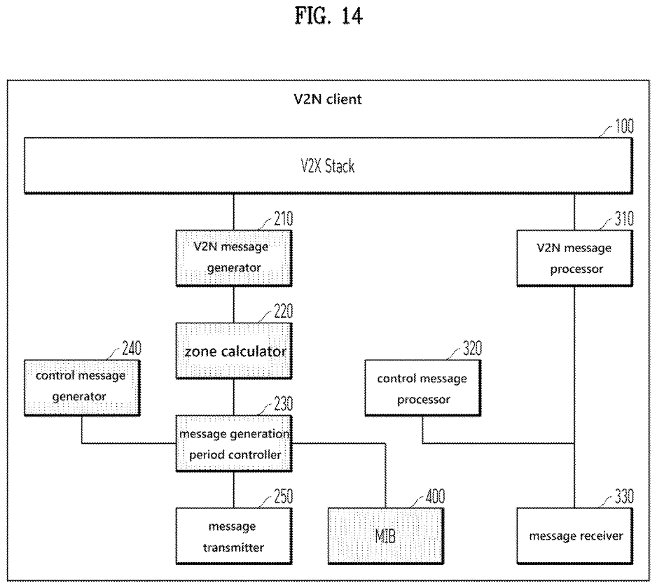

FIG. 14 is a simplified block illustrating the configuration of a UE that performs message transmission and reception with a server.

Referring to FIG. 14, a UE (or V2N client) may include a V2X stack 100, a V2X message generator 210, a zone calculator 220, a message generation period controller 230, a control message generator 240, a message transmitter 250, a V2N message processor 310, a control message processor 320, a message receiver 330, and an MIB 400.

The control message generator 240 may generate a real-time data message to be transmitted to a server or another UE. The message generation period controller 230 may determine/adjust a transmission order between a message (or a first message) including the generated real-time data and a V2X message (or a V2N message). The priority and status information (e.g., status parameters for the UE, server, and network managed in the MIB 200) of the message (or message including the real-time data) may be used for buffering/filtering (e.g., the real-time data message, V2N message, and/or V2X message). Thereafter, the real-time data message may be transmitted to the message transmitter 250 and then transmitted to the server through the MQTT protocol.

In other words, the UE (or V2N client) may generate a real-time data message to be transmitted to the server or another UE through the control message generator 240, and generate a V2N message or a V2X message through the V2N message generator (or V2X message generator). The message generation period controller 230 may determine a transmission time or delay time of the real-time data message based on a priority configured for the real-time data message.

Hereinbelow, a method of determining a transmission time of a message including real-time data based on a priority set for the message including the real-time data by a UE will be described in detail.

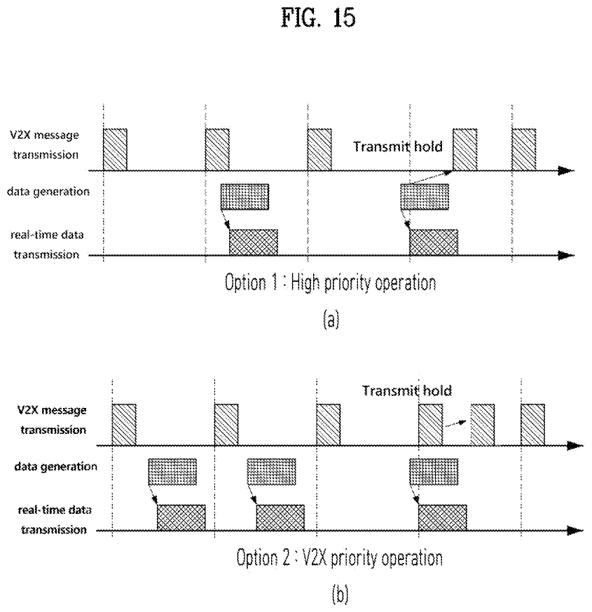

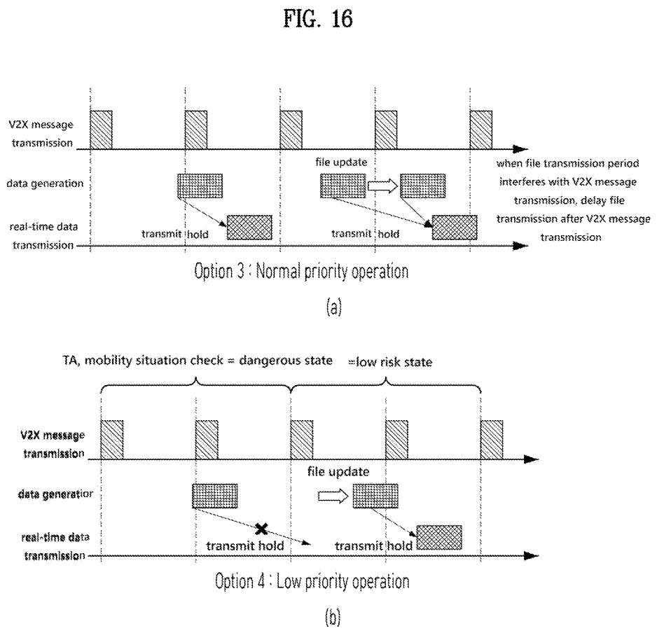

FIGS. 15 and 16 are diagrams illustrating a method of transmitting a message including real-time data based on a priority configured for the real-time data message by a UE.

Four levels of priorities may be set for real-time data. For example, the four levels of priorities may include a first priority (high priority) as a highest priority, a second priority (V2X priority), a third priority (normal priority), and a fourth priority (low priority). The first priority may be set for real-time data, which is control data for maintaining/controlling a V2X-based safety system. For example, the first priority may be set for real-time data including control information for transmission or control of a V2X message or a V2N message. The real-time data with the first priority may be transmitted with priority over the transmission of the V2X message.

Referring to FIG. 15(a), real-time data with the first priority (high priority) may be transmitted with priority over transmission of a V2X message. For example, when there is no transmission of a V2X message (or SoftV2X message), the real-time data may be transmitted immediately after it is generated. The V2X message may be transmitted immediately after the transmission of the real-time data is completed. Alternatively, when the real-time data with the first priority is generated during the transmission of the V2X message, the real-time data may be transmitted immediately after the transmission of the V2X message is completed. Alternatively, when the real-time data with the first priority is generated during the transmission of the V2X message, the UE may stop the transmission of the V2X message and transmit the real-time data. Herein, the real-time data with the first priority may be transmitted immediately regardless of status information received from an internal management block and an external management block. For example, even if the UE or device is in the dangerous state, the real-time data with the first priority may be transmitted immediately without considering the UE or device in the dangerous state.

Specifically, referring to FIG. 15(b), real-time data with the second priority may be transmitted in consideration of a transmission period of a V2X message or a generation time of the V2X message. For example, the real-time data with the second priority (V2X priority) may have the same priority as the V2X message. In this case, when the real-time data is generated or transmitted to a transmission buffer earlier than the V2X message, the real-time data may be transmitted before the V2X message. In this case, the V2X message may be transmitted with a delay from the set transmission period. Alternatively, when the V2X message is generated and transmitted to the transmission buffer earlier than the real-time data (i.e., when the transmission is requested), the V2X message may be transmitted with priority over the real-time data, and when the transmission of the V2X message is completed, the real-time data may be transmitted. Alternatively, the facility layer may adjust a transmission time of a message including the real-time data in consideration of a transmission period of a periodic V2X message, thereby minimizing collisions between the V2X message and the message. For example, the real-time data with the second priority may be transmitted at a midpoint that does not overlap with the time of the periodic V2X message (i.e., the midpoint of the period of the V2X message) (alternatively, basically required data is transmitted at a midpoint that does not overlap with the time of the periodic V2X message, and the latest data is transmitted for this purpose).

In other words, the real-time data with the second priority may have the same priority as the transmission of the V2X message. The real-time data may be generated without considering the generation/transmission period of the V2X message. In this case, since the real-time data and the V2X message have the same priority, the UE may transmit a message with priority, which is (generated earlier and) transmitted earlier to the transmission buffer out of the message including the real-time data and the V2X message.

The real-time data with the second priority may be transmitted by additionally using/considering status information received from the internal management block and the external management block described above.

Next, real-time data with the third priority (normal priority) may have a lower priority than a V2X message. In this case, even if a message including the real-time data is generated before the V2X message, when it interferes with the transmission of the V2X message to be generated later (e.g., a situation where a transmission period of the V2X message overlaps with a transmission period of the real-time data), the transmission of the message may be delayed until the transmission of the V2X message is completed. That is, when there is a concern that the message including the real-time data with the third priority will collide with the transmission of the V2X message based on the transmission time/transmission period of the V2X message, the message may be transmitted after a delay.

Specifically, referring to FIG. 16(a), when real-time data having the third priority is generated, the UE may calculate/predict a transmission period of the real-time data. In this case, when a time at which the transmission of the real-time data is completed overlaps with a transmission period of the V2X message, the UE may delay the transmission of the real-time data. In other words, the UE may predict/calculate a first transmission period of the real-time data, and when the first transmission period overlaps with a second transmission period of the V2X message, the UE may delay the transmission time of the real-time data until a time when the transmission of the V2X message is completed. When the time delay of the transmission of the real-time data is equal to or greater than a specific threshold, the UE needs to update a value included in the real-time data to the latest value in order to secure the real-time nature of the real-time data. To this end, the UE may predict/obtain a V2X transmission period and transmission time based on V2X transmission parameters and status information (the status of the network, server, and/or UE) of the internal management block, and predict the next transmission time of the real-time data. When the first transmission period does not overlap with the second transmission period, the UE may immediately transmit the message including the real-time data.

In other words, the UE may predict the second transmission period of the V2X message based on the first transmission period, which is the transmission period of the message including the real-time data, the transmission parameters of the V2X message, and the status information about the UE, in consideration of the size of the real-time data. When the first transmission period and the second transmission period partially (or completely) overlap, the UE may delay the transmission of the message including the real-time data until an ending time of the second transmission period. The UE may predict/calculate a delay time of the transmission of the real-time message. When the predicted/calculated delay time is equal to or greater than a specific threshold, the UE may update the real-time message to change the value included in the real-time data to the latest value. That is, the UE may determine whether the real-time data needs to be updated based on the delay time. For example, when the delay time is less than the specific threshold, the UE may perform the delayed transmission without updating the real-time data, and when the delay time is equal to or greater than the specific threshold, the UE may perform the delayed transmission after updating the real-time data.

Next, real-time data having the fourth priority (low priority) has a lower priority than a V2X message, and its transmission may be delayed in additional consideration of generation of an aperiodic V2X message or the risk state of the UE.

Specifically, referring to FIG. 16(b), when the real-time data with the fourth priority is generated, the UE may determine whether to transmit a message including the real-time data based on whether the status of the UE is a dangerous state (dangerous state analyzed using information of the internal management block and the external management block). If the status of the UE is the dangerous state, the UE does not transmit the real-time data having the fourth priority. The UE may delay the transmission of the real-time data until the status of the UE becomes the safe state. That is, when the status of the UE is the dangerous state, the transmission of the real-time data with the fourth priority may be delayed unlike the real-time data with the third priority, even if there is no concern that it will interfere with the transmission of a V2X message.

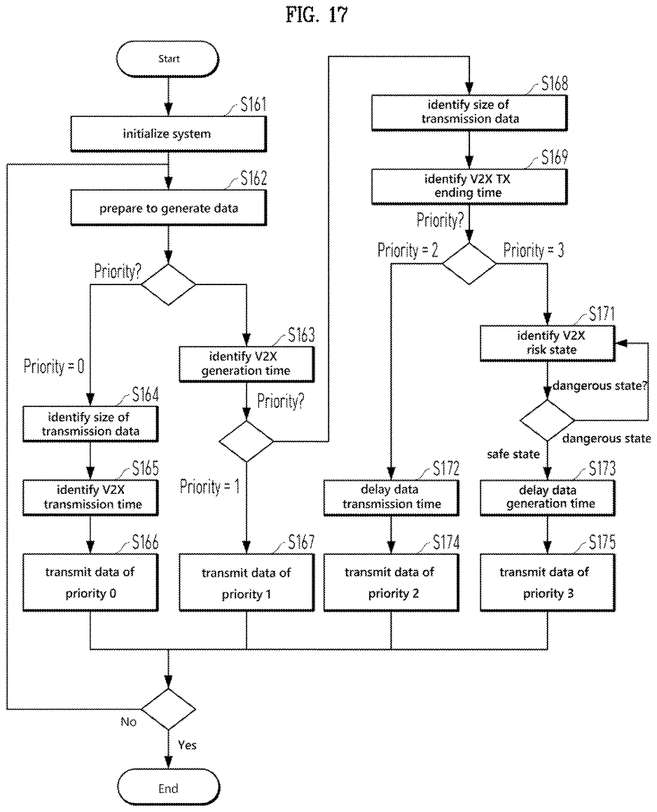

FIG. 17 is a diagram illustrating a method of transmitting a message including real-time data based on a priority by a UE.

Referring to FIG. 17, when an operation related to a real-time data transmission starts, a system is initialized (S161), and the UE may prepare to generate real-time data (S162). Thereafter, the UE may identify/analyze the priority of the real-time data to be transmitted. When the priority of the real-time data is ‘0’, the UE may set the priority of the real-time data to the first priority (high priority) and identify the size of the real-time data (S164), and when there is a generated V2X message, delay the transmission of the V2X message based on the size of the real-time data (S165). For example, when the periodic transmission of the V2X message interferes with the transmission of the real-time data, the UE may delay a transmission period or transmission time of the V2X message based on the size of the real-time data. The UE may immediately transmit a message (V2X message or V2N message) including the real-time data with the first priority without delaying it by considering the generation of the V2X message (S166). A header of the message including the real-time data may be set to a priority of ‘0’ or the first priority.

Alternatively, when the priority of the real-time data is not ‘0’, the UE may determine/obtain a generation time and generation period (or a transmission time and transmission period) of the V2X message based on transmission parameters related to the V2X message (S163). In the case where the priority of the real-time data is ‘l’, when a generation time of the real-time data is earlier than the V2X generation time, the real-time data may be immediately transmitted as in the transmission method for the second priority (V2X priority) (S167). In this case, the message including the real-time data (V2X message) may include a message header with a priority set to ‘l’.

Alternatively, when the priority of the real-time data is not 0 or 1, the UE may identify the size of the real-time data (or the size of the transmission data) (S168) and identify/predict an ending time when the transmission of the V2X message ends or is completed (S169). Thereafter, in the case of real-time data with a priority of ‘2’ (e.g., the third priority described above), the UE may delay the transmission time of the message including the real-time data (when there is a concern of collision between the V2X message and the message including the real-time data) until the ending time of the transmission of the V2X message (S172), and transmit the message including the real-time data after the ending time of the transmission (S174).

In the case of real-time data with a priority of 3 (the above-described fourth priority), the UE may predict/determine whether the UE is in the dangerous state based on obtained status information (sensing information about a location and mobility, location information included in messages received from neighboring UEs and/or vehicles, map information, and so on) (S171), and when the status of the UE is determined as the dangerous state, the UE may delay the transmission/generation of the message including the real-time data until the dangerous state is changed to the safe state, without immediately transmitting the message including the real-time data (S173). When the status of the UE is changed from the dangerous state to the safe state, the UE may transmit the message including the real-time data (S175).

Hereinbelow, the structure of a message including real-time data will be described in detail.

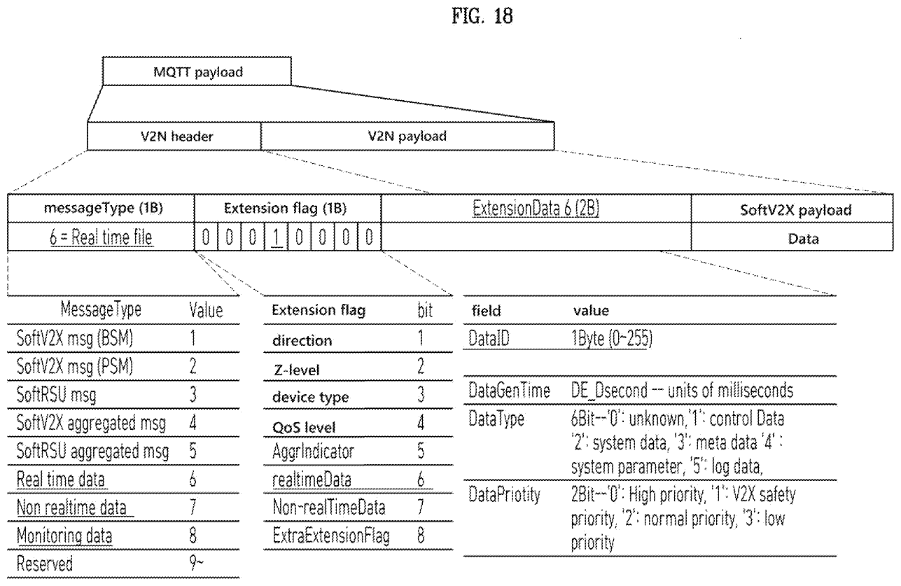

FIG. 18 is a diagram illustrating the structure of a message including real-time data.

Referring to FIG. 18, the message including the real-time data may be a V2N message. The V2N message may be transmitted based on MQTT. In this case, a V2N header and V2N payload of the V2N message may be included in MQTT payload. The V2N header may indicate the type of the V2N message in advance by messageType. For example, when the V2N message includes real-time data, the messageType in the header of the V2N message may be set to 6, which is a value for transmission of real-time data. The V2N header may include an Extension flag, and the Extension flag may indicate the existence of Extension field 6, which indicates additional information related to the real-time data. The Extension field identifies the real-time data by DataID having 8-bit random data, and DataGenTime may represent a time when the V2N message (or the real-time data) is generated as DE_Dsecond in milliseconds. DataType of 6 bits included in the Extension field 6 may provide information about the type of the real-time data. For example, DataType with a value of 0 may indicate that the type of the real-time data is undefined or unknown, DataType with a value of 1 may indicate that the real-time data is data for control data (including control information related to transmission and reception of a V2M message), DataType with a value of 2 may indicate that the real-time data is data for system information (e.g., system information related to a V2N system or a SoftV2X system), DataType with a value of 3 may indicate that the real-time data is metadata, DataType with a value of 4 may indicate that the real-time data is for a system parameter, and DataType with a value of 5 may indicate that the real-time data is log data for log information.

A DataPriority field of 2 bits included in the Extension field 6 may provide information about one of the priorities 0, 1, 2, and 3 (or the first priority, second priority, third priority, and fourth priority) described above. For example, when the value of the DataPriority field is 0, the priority of the real-time data is the first priority (high priority), when the value of the DataPriority field is 1, the priority of the real-time data is the second priority (V2X priority), when the value of the DataPriority field is 2, the priority of the real-time data is the third priority (normal priority), and when the value of the DataPriority field is 4, the priority of the real-time data is the fourth priority (low priority).

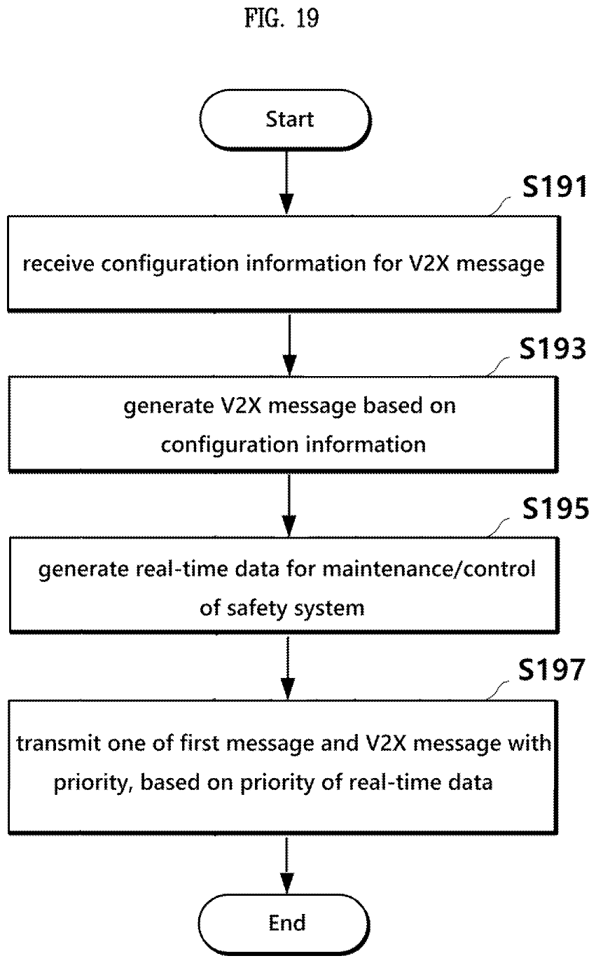

FIG. 19 is a diagram illustrating a method of transmitting a message including real-time data based on the priority of the real-time data by a UE.

Referring to FIG. 19, the UE may receive configuration information for a V2X message (S191). The configuration information may include transmission parameters for the V2X message, such as a transmission period and a message size of the V2X message. The UE may generate the V2X message based on the received configuration information (S193).

In addition, the UE may generate real-time data to be provided to a network, for maintenance/control of a safety system based on the V2X message (S195). As described above, the UE may independently generate real-time data required in real time in relation to the safety system (SoftV2X system or V2N system) based on the V2X message, in addition to the V2X message, to provide the real-time data to the network or other UEs. For example, the real-time data may be control data for controlling the safety system, data for system information related to the safety system, metadata related to the safety system, data for a system parameter related to the safety system, and/or log data related to the safety system.

The priority of the real-time data may be set based on the data type and importance of the real-time data in the safety system. As described above, the priority may be a priority regarding whether the transmission of the real-time data has priority over the transmission of the V2X message in a relationship with the V2X message as described above. Specifically, the priority may include the first priority over the priority of the transmission of the V2X message, the second priority that is the same as the priority of the transmission of the V2X message, the third priority below the priority of the V2X message, and the fourth priority requiring additional consideration of status information about the UE. For example, when the real-time data is control data that should be transmitted in real time, the real-time data may be set to the first priority. When the real-time data is data (such as system information) that does not need to be transmitted with priority over the V2X message even if it is necessary in real time, the real-time data may be set to the second priority. When the real-time data includes data (e.g., metadata for the system or a system parameter) of lower importance than the V2X message, the real-time data may be set to the third priority. When the real-time data includes data (e.g., log data related to the system) that is not sensitive to a specific time delay, the real-time data may be set to the fourth priority.

The UE may transmit one of the first message and the V2X message with priority based on the priority of the real-time data (S197). For example, when the transmission of the first message based on generation of the real-time data needs to be performed within a transmission period in which the V2X message is to be transmitted based on the configuration information, the UE may transmit the V2X message or the first message with priority based on the priority of the real-time data and delay the transmission of the other message. For example, the first message including the real-time data set to the first priority may be transmitted with priority over the V2X message without delay within the transmission period of the V2X message determined/predicted based on the configuration information, and the V2X message may be transmitted with a delay after the transmission of the first message is completed. That is, the real-time data set to the first priority may be transmitted to a transmission buffer of the UE immediately after it is generated, and transmitted through the first message, regardless of whether it overlaps with the transmission period of the V2X message.

Alternatively, the real-time data set to the second priority or the third priority may be delayed in transmission in relation to the V2X message, and the real-time data set to the fourth priority may be delayed in transmission by additionally considering not only the relationship with the V2X message but also whether the status of the UE is the dangerous state.

Specifically. when the real-time data has the first priority (or the real-time data is set to the first priority), the first message including the real-time data may be generated/transmitted within the transmission period of the V2X message without considering whether the V2X message is generated first or is being transmitted. In other words, the first message including the real-time data with the first priority may be transmitted with priority without delay in relation to the V2X message, and the transmission of the V2X message may be delayed until a time when the transmission of the first message is completed. For example, when the first message is generated during the transmission of the V2X message, the UE may stop the transmission of the V2X message and transmit the first message. Alternatively, the first message including the real-time data with the first priority may be transmitted with priority over the V2X message, even if the V2X message is generated first. In this case, the transmission of the V2X message may be delayed until the transmission of the first message including the real-time data is completed.

Alternatively, when the real-time data has the second priority, the UE may determine whether to delay the transmission of the first message including the real-time data with the second priority by considering a generation time of the V2X message. For example, when the real-time data has the second priority, the UE may identify whether there is a currently generated V2X message and, if so, a generation time of the V2X message. The UE may determine whether the generation time of the V2X message is earlier than a generation time of the real-time data. When the generation time of the V2X message is earlier than the generation time of the real-time data, the UE may delay the transmission of the first message including the real-time data until a time (hereinafter, a first delay time) when the transmission of the first message is completed. When the generation time of the V2X message is later than the generation time of the real-time data, the UE may transmit the first message including the real-time data without delay and delay the transmission of the V2X message until a time when the transmission of the first message is completed.

Alternatively, when the real-time data has the third priority, the UE may determine a first transmission period based on the size of the real-time data and determine a second transmission period based on the size and transmission period of the V2X message. When the first transmission period overlaps partially or completely with the second transmission period, the UE may delay the transmission of the first message until the first delay time, which is the time when the transmission of the V2X message is completed. In this case, the UE may transmit the first message after the first delay time. When the first transmission period does not overlap with the second transmission period, the UE may transmit the first message without delay.

Alternatively, when the real-time data has the fourth priority, the UE may determine a transmission delay time of the first message by considering even a UE status predicted for the UE. For example, when the UE status is the dangerous state, the UE may delay the transmission of the first message, even if it does not overlap with the transmission period of the V2X message. The UE may delay the transmission of the first message until a second delay time when the UE status is switched from the dangerous state to the safe state. In this case, the UE may transmit the first message in a transmission period that does not overlap with the transmission period of the V2X message after the second delay time.

Based on the transmission of the first message being delayed until the first delay time, the UE may update the real-time data to a latest value (at the delay time) based on the length of a delay period from the generation time of the real-time data to the first delay time being equal to or larger than a specific threshold time, and transmit the first message including the updated real-time data after the first delay time. Alternatively, based on the transmission of the first message being delayed until the second delay time, the UE may update the real-time data to the latest value based on the length of the delay period from the generation time of the real-time data to the second delay time being equal to or larger a specific threshold time, and transmit the first message including the updated real-time data after the second delay time.

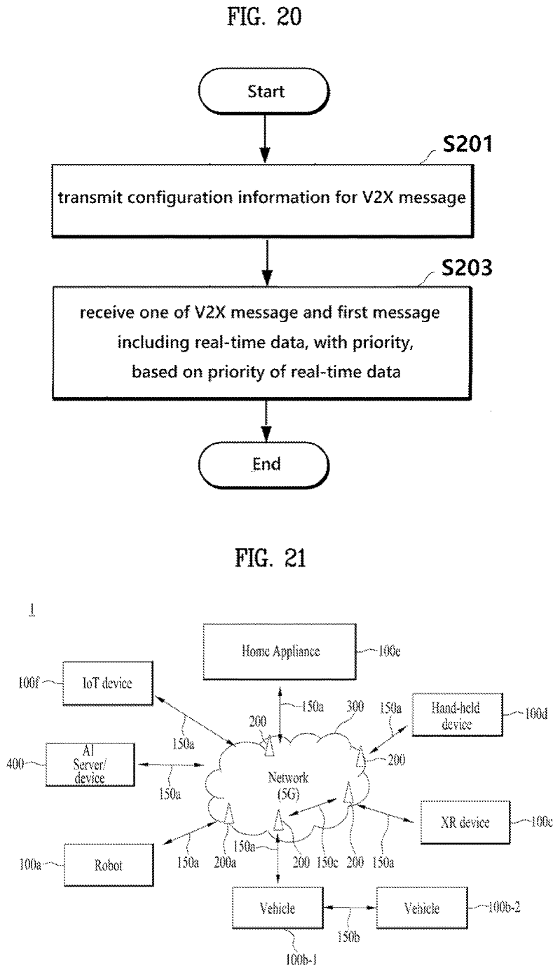

FIG. 20 is a diagram illustrating a method of receiving a message including real-time data from a UE by a network.

Referring to FIG. 20, the network may transmit configuration information for a V2X message to the UE (S201). The configuration information may include information about transmission parameters such as a transmission period and a message size of the V2X message. The network may be the above-described server, V2N server, or SoftV2X server.

The network may receive one of the V2X message generated based on the configuration information and a first message including real-time data generated for a system based on the V2X message, with priority (S203). For example, the network may receive the first message including the real-time data transmitted with a delay, after receiving the V2X message based on a priority configured for the real-time data, as described above. Alternatively, the network may receive the V2X message transmitted with a delay, after receiving the first message including the real-time data based on the priority set for the real-time data, as described above.

In other words, the network may determine/predict reception times of a message to be received first and a message to be transmitted with a delay out of the V2X message and the first message, based on the priority of the received real-time data and the configuration information. The network may receive data required in real time from the UE in relation to a safety system (SoftV2X system or V2N system) based on the V2X message. For example, the real-time data may include control data for maintenance/control of the safety system based on the V2X message, system information, metadata, a system parameter, and/or log data.

The priority of the real-time data may be set based on a data type and importance of the real-time data in the safety system. As described above, the priority may be a priority regarding whether the transmission of the real-time data has priority over the transmission of the V2X message in a relationship with the V2X message as described above. Specifically, the priority may include the first priority over the priority of the transmission of the V2X message, the second priority that is the same as the priority of the transmission of the V2X message, the third priority below the priority of the V2X message, and the fourth priority requiring additional consideration of status information about the UE. For example, when the real-time data is control data that should be transmitted in real time, the real-time data may be set to the first priority. When the real-time data is data (such as system information) that does not need to be transmitted with priority over the V2X message even if it is necessary in real time, the real-time data may be set to the second priority. When the real-time data includes data (e.g., metadata for the system or a system parameter) of lower importance than the V2X message, the real-time data may be set to the third priority. When the real-time data includes data (e.g., log data related to the system) that is not sensitive to a specific time delay, the real-time data may be set to the fourth priority.

A reception time at which the network receives the first message including the real-time data may be determined based on the priority of the real-time data. For example, in the case of the first message including the real-time data with the first priority, the network may receive the first message without delay.

Alternatively, the transmission of the real-time data with the second priority or the third priority may be delayed in relation to the V2X message, and the transmission of the real-time data with the fourth priority may be delayed in consideration of not only a relationship with the V2X message but also whether a UE status is the dangerous state.

Specifically, when the real-time data has the second priority, the network may receive the first message and the V2X message in a reception order determined according to a generation time of the V2X message and a generation time of the real-time data. For example, when the real-time data has the second priority and the generation time of the V2X message is earlier than the generation time of the real-time data, the network may first receive the V2X message and then receive the first message including the real-time data with a delay, after a first delay time at which the reception of the V2X message is completed. Alternatively, when the generation time of the V2X message is later than the generation time of the real-time data, the network may first receive the first message and then receive the V2X message transmitted with a delay.

Alternatively, when the real-time data has the third priority, and a first reception period determined based on the size of the real-time data and a second reception period determined based on the size and transmission period of the V2X message partially/completely overlap with each other, the network may receive the first message including the real-time data after receiving the V2X message. That is, the network may receive the first message with a delay after the first delay time.

Alternatively, when the real-time data has the fourth priority and the UE status is the dangerous state, the network may receive the V2X message, and receive the first message delayed until a second delay time. The second delay time may be a time when the UE status changes from the dangerous state to the safe state.

When the transmission of the first message is delayed until the first delay time, and the length of a delay period from the generation time of the real-time data to the first delay time is equal to or larger than a specific threshold time, the network may receive the first message including the real-time data updated to the latest value in relation to the first delay time. Alternatively, when the transmission of the first message is delayed until the second delay time, and the length of a delay period from the generation time of the real-time data to the second delay time is equal to or larger than a specific threshold time, the network may receive the first message including the real-time data updated to the latest value in relation to the second delay time. That is, the network may determine whether the real-time data included in the first message has been updated to a latest value according to the delay, based on the first delay time (or the second delay time) and the specific threshold time.

In this way, even if the V2X message and the first message including the real-time data are transmitted based on MQTT, communication performance degradation caused by the transmissions of the two messages may be minimized by separately setting a priority for the real-time data. As the priority of the real-time data is set based on the importance of the real-time data and the necessity of real-time acquisition, the transmission order of the V2X message and the first message may be efficiently determined. Even if each of the V2X message and the first message is transmitted based on MQTT, the deterioration of the real-time nature of the real-time data and the interference with safety assurance caused by the V2X message may be minimized by determining the transmission order of the V2X message and the first message based on the priority.

Communication System Example to which the Present Disclosure is Applied

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

FIG. 21 illustrates a communication system applied to the present disclosure.

Referring to FIG. 21, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IOT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices to which the Present Disclosure is Applied

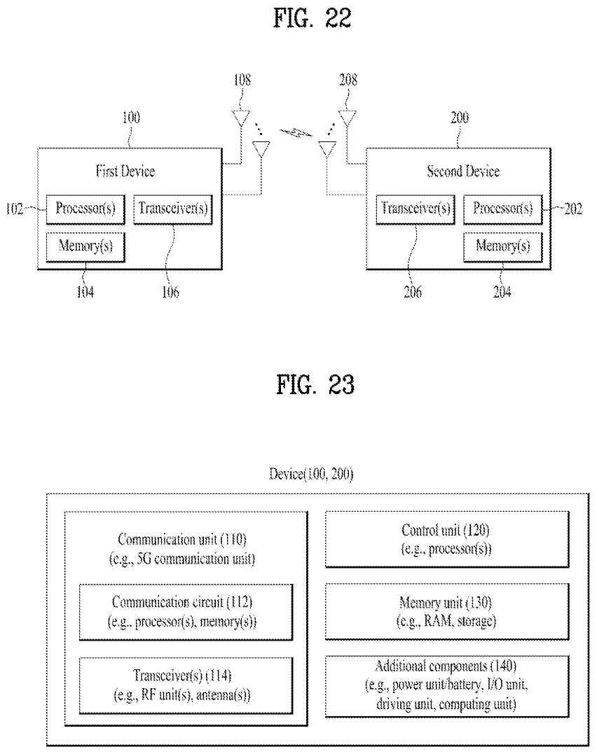

FIG. 22 illustrates a wireless device applicable to the present disclosure.

Referring to FIG. 22, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 21.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

Specifically, the first wireless device or first device 100 may include the processor 102 connected to the transceiver 106, and the memory 104. The memory 104 may include at least one program for performing an operation related to the embodiments described with reference to FIGS. 11 to 19.

The processor 102 may control the transceiver 106 to receive configuration information including information about a size and a transmission period of a V2X message from a network, generate the V2X message based on the configuration information, generate real-time data, and transmit a first message including the real-time data to the network. A transmission time of the first message may be delayed until a first delay time or a second delay time based on a priority configured for the real-time data. The first delay time may be a time when transmission of the V2X message is completed, and the second delay time may be a time when a predicted UE status is changed from a dangerous state to a safe state based on status information obtained for the UE.

Alternatively, the processor 102 and the memory 104 may be a processing device configured to control a UE that transmits real-time data to a network in a wireless communication system. The processing device may include at least one memory 104 connected to the at least one processor and storing instructions which based on being executed by the at least one processor, cause the UE to receive configuration information for a V2X message from the network, generate the V2X message based on the configuration information, generate real-time data for a system based on the V2X message, and transmit one of the first message and the V2X message with priority based on a priority configured for the real-time data, based on a transmission period of the V2X message and a transmission period of the first message overlapping with each other. Based on the one message being the V2X message, transmission of the first message may be delayed until a first delay time which is a time when transmission of the V2X message is completed, or a second delay time which is a time when a UE status is changed, based on the UE status. The UE status may be determined as a dangerous state or a safe state based on a collision risk level calculated using status information obtained for the UE.

Alternatively, in a non-transitory computer-readable storage medium storing instructions which when executed, cause a UE to receive configuration information for a V2X message from the network, generate the V2X message based on the configuration information, generate real-time data for a system based on the V2X message, and transmit one of the first message and the V2X message with priority based on a priority configured for the real-time data, based on a transmission period of the V2X message and a transmission period of the first message overlapping with each other. Based on the one message being the V2X message, transmission of the first message may be delayed until a first delay time which is a time when transmission of the V2X message is completed, or a second delay time which is a time when a UE status is changed, based on the UE status. The UE status may be determined as a dangerous state or a safe state based on a collision risk level calculated using status information obtained for the UE.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

The second wireless device 200 or a network may be a V2N server or a SoftV2X server that provides a safety service based on a V2X message. The processor 202 may control the transceiver 206 to transmit configuration information including information about a size and a transmission period of a V2X message to a UE, receive the V2X message based on the configuration information, and receive a first message including real-time data. A reception time of the first message may be delayed until a first delay time or a second delay time, based on a priority configured for the real-time data. The first delay time may be a time when reception of the V2X message is completed, and the second delay time may be a time when a predicted UE status is changed from a dangerous state to a safe state, based on status information obtained for the UE.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of Wireless Devices to which the Present Disclosure is Applied

FIG. 23 illustrates another example of a wireless device applied to the present disclosure. The wireless device may be implemented in various forms according to a use-case/service (refer to FIG. 21)

Referring to FIG. 23, wireless devices 100 and 200 may correspond to the wireless devices 100 and 200 of FIG. 22 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 22. For example, the transceiver(s) 114 may include the one or more transceivers 106 and 206 and/or the one or more antennas 108 and 208 of FIG. 22. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 21), the vehicles (100b-1 and 100b-2 of FIG. 21), the XR device (100c of FIG. 21), the hand-held device (100d of FIG. 21), the home appliance (100e of FIG. 21), the IoT device (100f of FIG. 21), a digital broadcast terminal, a hologram device, a public safety device, an MTC device, a medicine device, a fintech device (or a finance device), a security device, a climate/environment device, the AI server/device (400 of FIG. 21), the BSs (200 of FIG. 21), a network node, etc. The wireless device may be used in a mobile or fixed place according to a use-example/service.

In FIG. 23, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Examples of vehicles or autonomous vehicles to which the present disclosure is applied

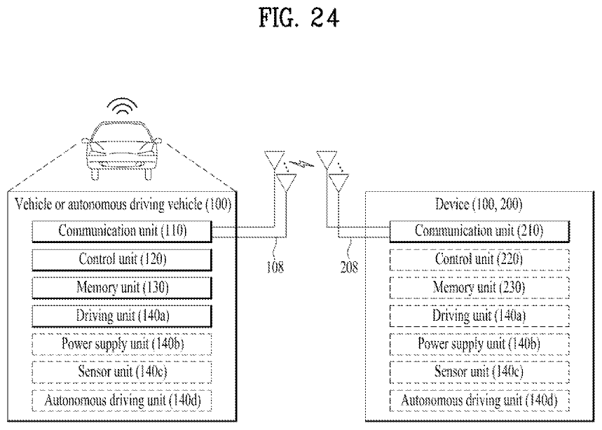

FIG. 24 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 24, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 21, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). Also, the driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the acquired data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly acquired data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Here, wireless communication technologies implemented in the wireless devices (XXX, YYY) of the present specification may include LTE, NR, and 6G, as well as Narrowband Internet of Things for low power communication. At this time, for example, the NB-IOT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology can generate personal area networks (PANs) related to small/low-power digital communication based on various standards such as IEEE 802.15.4, and may be called various names.

The embodiments described above are those in which components and features of the present disclosure are combined in a predetermined form. Each component or feature should be considered optional unless explicitly stated otherwise. Each component or feature may be implemented in a form that is not combined with other components or features. In addition, it is also possible to constitute an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present disclosure have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure. For example, those skilled in the art may use the components described in the foregoing embodiments in combination. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The embodiments of the present disclosure described above are applicable to various mobile communication systems.

1. A method by a user equipment (UE) comprising:
receiving configuration information for a vehicle to everything (V2X) message from the network;
generating the V2X message based on the configuration information;
generating real-time data for a system based on the V2X message; and
based on a transmission period of the V2X message overlapping with a transmission period of a first message including the real-time data, transmitting one of the first message and the V2X message with priority, based on a priority configured for the real-time data,
wherein, based on the one message being the V2X message, transmission of the first message is delayed until a first delay time or a second delay time based on a UE status,
wherein the first delay time is a time at which a transmission of the V2X message is completed, and the second delay time is a time at which the UE state changes, and
wherein the UE status is determined as a dangerous state or a safe state, based on a collision risk level calculated using status information obtained for the UE.

2. The method of claim 1, wherein based on the transmission of the first message being delayed until the second delay time, the real-time data is updated based on a length of a delay period from a generation time of the real-time data to the second delay time being equal to or greater than a specific threshold time.

3. The method of claim 1, wherein the first message includes a vehicle to network (V2N) header including information about the priority of the real-time data.

4. The method of claim 1, wherein based on the real-time data having the same priority as the transmission of the V2X message, a transmission time of the first message is delayed until the first delay time, based on a generation time of the real-time data later than a generation time of the V2X message, or the transmission of the V2X message is delayed until a time when the transmission of the first message is completed, based on the generation time of the V2X message later than the generation time of the real-time data.

5. The method of claim 4, wherein based on the real-time data having the same priority as the transmission of the V2X message, the first message is transmitted without delay based on the generation time of the real-time data earlier than the generation time of the V2X message.

6. The method of claim 1, wherein based on the real-time data having a lower priority than the transmission of the V2X message, the transmission of the first message is delayed until the first delay time based on the UE status being the safe state.

7. The method of claim 1, wherein based on the real-time data having a lower priority than the transmission of the V2X message, the transmission of the first message is delayed until a second time based on the UE status being the dangerous state.

8. The method of claim 1, wherein the first message and the V2X message are transmitted based on message queuing telemetry transport (MQTT).

9. (canceled)

10. A user equipment (UE) comprising:
a radio frequency (RF) transceiver; and
a processor connected to the RF transceiver,
wherein the processor controls the RF transceiver to receive configuration information for a vehicle to everything (V2X) message from the network, generate the V2X message based on the configuration information, generate real-time data for a system based on the V2X message, and based on a transmission period of the V2X message overlapping with a transmission period of a first message including the real-time data, transmit one of the first message and the V2X message with priority, based on a priority configured for the real-time data, and
wherein, based on the one message being the V2X message, transmission of the first message is delayed until a first delay time or a second delay time based on the UE status,
wherein the first delay time is a time at which a transmission of the V2X message is completed, and the second delay time is a time at which the UE state changes, and
wherein the UE status is determined as a dangerous state or a safe state, based on a collision risk level calculated using status information obtained for the UE.

11. (canceled)

12. A method by a network comprising:
transmitting configuration information for a vehicle to everything (V2X) message to the UE; and
receiving one of the V2X message generated based on the configuration information and a first message including real-time data generated for a system based on the V2X message, with priority,
wherein based on the one message being the V2X message, reception of the first message is delayed until a first delay time or a second delay time based on the UE status,
wherein the first delay time is a time at which a reception of the V2X message is completed, and the second delay time is a time at which the UE state changes, and
wherein the UE status is determined as a dangerous state or a safe state, based on a collision risk level calculated using status information obtained for the UE.

13.-15. (canceled)
